(19) United States
(12) Patent Application Publication
(10) Pub. No.: US 2005/0102073 A1
(43) Pub. Date: May 12, 2005

(54) Tire management system and method

(76) Inventor: Rupert Henry Ingram II, Sanibel, FL (US)

Correspondence Address: CHOATE, HALL & STEWART LLP, EXCHANGE PLACE, 53 STATE STREET, BOSTON, MA, 02109, US

(21) Appl. No.: 10/806,670

(22) Filed: Mar. 22, 2004

Related U.S. Application Data
(60) Provisional application No. 60/456,837, filed on Mar. 21, 2003.

(51) Int. Cl. G06F 17/00

(52) U.S. Cl. 701/29; 340/442

(57) ABSTRACT

In one aspect, the invention is a system and method for improving vehicle operating conditions through the monitoring and adjustment of tire pressure in response to changing conditions. The system improves commercial vehicle productivity by reducing tire and fuel expenses, improving traction when needed, and reducing tire-induced shock-load damage to the vehicle axles and chassis. In another aspect, the invention is a tire management system, comprised of a tire inflation and deflation system positioned onboard said vehicle and operationally controlled by an onboard microprocessor-based control unit or by a remote centralized control-unit.

### CROSS REFERENCE TO RELATED APPLICATIONS

The present application claims priority to U.S. Provisional Application No. 60/456,837, filed Mar. 21, 2003, which is incorporated herein by reference.

### FIELD OF THE INVENTION

The present invention is directed to the field of the monitoring and maintenance of vehicle operating conditions and more particularly to a system and method for tire management.

### BACKGROUND OF THE INVENTION

On-board vehicular tire pressure management systems that either inflate tires that have lost pressure or can both inflate and deflate vehicle tires to suit a range of operating conditions during vehicle operation, referred to as central tire inflation (CTI) systems, are known in the prior art. (See, for example, U.S. Pat. Nos. 5,141,589, 4,862,938, and U.S. Pat. No. 4,782,878 all to Mittal). Such CTI systems typically include a supply of pressurized air and controls for selectively changing existing tire pressure and for determining current tire pressures for each tire. The pressurized air is provided by a pressurized air source onboard the vehicle. Systems of the prior art further include electronic circuitry by which signals corresponding to desired and existing tire pressures are electronically compared and which generate output signals to control the inflating and deflating functions.

Onboard monitoring systems provide information to the CTI systems as to when tire pressures require adjustment and improve the control and effectiveness of vehicle tire inflation and deflation. (See, for example, U.S. Pat. Nos. 5,629,874 and 5,540,268 both to Mittal, and U.S. Pat. No. 5,629,873 to Mittal, et al.). Such onboard systems monitor tire status and adjust tire pressure to improve driving performance based on changing conditions including weather, vehicular load, terrain and vehicular speed. These systems generally require a vehicle occupant (e.g. driver) to select the correct tire pressures, while some allow automation of these functions. Such CTI systems do not allow for the centralized assessment of, recording of, or response to operating data from a remotely controlled unit.

Frequently, the tires on a fleet of trucks are not owned by the truck owner but are leased from a tire service provider. Where a tire service provider manages the tires of a client fleet, its tire service staff must frequently travel to each vehicle to assess tire performance and perform necessary maintenance and repairs. This is logistically difficult and economically inefficient. Because the typical commercial vehicle visits base infrequently and irregularly, many inspection visits are required to assess tire performance for a given vehicle. The average fleet includes many vehicles, multiplying the logistical problem of assessing and managing tire performance. Furthermore, neither the fleet nor the tire service providers cannot perform real-time monitoring of tire performance to predict tire problems before they occur and record unpredictable tire problems as they happen to identify cause and accountability.

There is therefore a need for a tire monitoring system capable of both onboard and remote assessment, recording, processing and analysis of vehicular operating conditions, and adjustment of tire pressures to suit current operating conditions and operating objectives.

### SUMMARY OF THE INVENTION

The present invention provides a system and method for improving vehicle operating conditions and reducing tire management cost through the monitoring and adjustment of tire pressure in response to changing conditions. The system improves commercial vehicle productivity by reducing tire and fuel expenses, modifies traction as desired, and reduces both vehicle downtime and tire-induced shock-load damage to the vehicle axles, chassis and cargo.

In one aspect, the invention is a tire management system. The tire management system includes a primary control unit positioned onboard a vehicle having at least one tire, a central secondary control unit spaced apart from said vehicle and in wireless communication with said primary control unit, a central tire inflation (CTI) system positioned onboard the vehicle and operationally controlled by said primary control unit, and at least one pressure gauge disposed onboard the vehicle and adapted and constructed to measure tire pressure and transmit tire pressure information to the primary control unit. The pressure gauge may be disposed in the CTI system or at a tire. The CTI system may be in fluid communication with an onboard pressurized air source for supplying pressurized air to the tires. The CTI system may be connected to at least one tire to control the inflation and deflation of the tire by supplying or exhausting pressurized air.

At least one of the primary control unit or the secondary control unit may be adapted and constructed to monitor tire pressure using tire pressure information provided by the pressure gauge. The tire management systems may further include a communication device that provides wireless communication between the primary control unit and the central secondary control unit. The central secondary control unit may be adapted and constructed to provide a targeted tire pressure, an operational objective, or both, for the primary control unit.

The system may further include at least one condition sensing component positioned onboard the vehicle. The condition sensing component is adapted and constructed to transmit sensitive information to the primary control unit. For example, the condition sensing device may be a vehicle load weight sensing device, a tire tread depth sensor, a tire tread separation sensor, a wheel balance sensor, a wheel alignment sensor, an axle alignment sensor, a tire slippage sensor, a breaking sensor, a data link to an ABS, a road condition vibration sensor, a vehicle speed sensing device, an ambient temperature sensor, a tire temperature sensor, a barometer, a GPS device, a fuel consumption meter, or some combination of these.

The tire management system may further include a display and input panel positioned aboard the vehicle and adapted and constructed to allow input and output access by a vehicle occupant. The panel is adapted and constructed to receive information signals from the primary control unit and input from the vehicle occupant. The primary control unit may be adapted and constructed to receive data from the tire pressure gauge and display the data to the vehicle occupant on the display and input panel. The primary control unit may be adapted and constructed to receive data from at least one condition sensing component and at least tire pressure gauge and display the data to the vehicle occupant on the display and input panel.

The primary control unit may be adapted and constructed to use data from at least one tire pressure gauge or at least one condition sensing component, or both, to calculate a target tire pressure according to a predetermined operational objective. The primary control unit and/or the central secondary control unit may be adapted and constructed to control the CTI system without real-time input from a vehicle occupant, a user local to the central secondary control unit, or the central secondary control unit. The primary control unit may be adapted and constructed to allow a vehicle occupant to exercise direct control over the CTI system. The central secondary control unit may be adapted and constructed to allow a user to exercise direct control over the CTI system.

The central secondary control unit may be in electronic communication with a display and input panel. The central secondary control unit would then be adapted and constructed to receive operational data from the primary control unit and provide the data to the display and input panel. The display and input panel may be adapted and constructed to receive an input, e.g., from a target tire pressure, an operational objective, or both, to a user and transmit the input to the central secondary control unit. The central secondary control unit may be adapted and constructed to receive an operational objective from a user and transmit a target tire pressure or the operational objective to the central secondary control unit.

The central secondary control unit or the primary control unit may be adapted and constructed to process data from the tire pressure gauge to calculate a target tire pressure according to a predetermined operational objective. The operational objective may include one or more of increase in tire life, increase in traction, reduction in road damage, achievement of a tire pressure optimized for selected operational conditions, travel at a predetermined speed, travel on a particular surface, travel under a predetermined load weight, reduction in tire temperature, travel at a predetermined altitude, reduction of fuel consumption, and achievement of a predetermined contact area between a tire and a surface.

The tire management system may further include a plurality of primary control units, each positioned onboard a vehicle having a CTI system. The CTI system is operationally controlled by the primary control unit aboard its respective vehicle, and each primary control unit is in wireless communication with the central secondary control unit. Each of the plurality of primary control units may be adapted and constructed to maintain a target tire pressure and tires attached to the vehicle having a primary control unit, but the target tire pressure need not be the same for each primary control unit.

Each of the plurality of primary control units may be adapted and constructed to maintain a tire pressure in tires attached to the vehicle having the primary control unit according to a predetermined operational objective, but the operational objective need not be the same for each primary control unit. The second central secondary control unit may be adapted and constructed to calculate a target tire pressure for each vehicle based on a predetermined operational objective, but the operational objective need not be the same for each vehicle. The central secondary control unit may be adapted and constructed to calculate the operational objective for each vehicle using data received from the vehicle or a different vehicle.

In another aspect, the invention is a method of tire management. The method includes obtaining operational condition data using at least one condition sensing component positioned onboard a vehicle and transmitting the operational condition data to a central secondary control unit spaced apart from the vehicle. The method may further include displaying the operational condition data on a display and input panel disposed onboard the vehicle or in electronic communication with the central secondary control unit. The method may further include sending control systems to a CTI system disposed on the vehicle. The CTI system maintains a target pressure in at least one tire of the vehicle according to the control signals. The method may further include transmitting the operational condition data to a primary control unit onboard the vehicle. Transmitting the operational data to a central secondary control unit includes transmitting the operational data from the primary control unit to the central secondary control unit.

The method may further include receiving an operational objective at the primary control unit from the secondary control unit. The primary control unit sends control signals to a CTI system disposed on the vehicle according to the operational objective, and the CTI system maintains a target tire pressure in at least one tire of the vehicle according to the control signals. The method may further include receiving input to the primary control unit and maintaining a target pressure in at least one tire of the vehicle according to the input. The method may further include communicating control signals to a CTI system disposed onboard the vehicle.

The method may further include receiving input from a user local to the central secondary control unit and maintaining a target pressure in at least one tire of the vehicle according to the input. The input may include a target tire pressure, an operational objective, or both.

The method may further include recording at least a portion of the operational condition data in the central secondary control unit or reporting at least a portion of the operational condition data to a vehicle occupant, a user local to the central secondary control unit, or both. The condition sensing component may sense one or more of tire pressure, vehicle load weight, tire tread depth, tire tread separation, wheel balance, wheel alignment, axle alignment, tire slippage, braking strength, a data link from an onboard ABS, road condition, axle vibration, vehicle speed, ambient temperature, tire temperature, altitude, atmospheric pressure, geographic location, fuel consumption level, or fuel consumption rate.

In another aspect, the invention is a method of tire management including receiving operational condition data from a vehicle at a location spaced apart from the vehicle. The operational condition data is collected from at least one condition sensing component positioned onboard the vehicle. The method may further comprise setting an operational objective for the vehicle at the central secondary control unit. The central secondary control unit transmits the operational objective, a target tire pressure, or both, to the vehicle. The method may further include causing a service provider to visit the vehicle in response to the received operational condition data. The method may further include receiving operational condition data from a plurality of vehicles at a location spaced apart from at least a portion of said plurality of vehicles.

### BRIEF DESCRIPTION OF THE DRAWING

The invention is described with reference to the figures of the drawing, in which:

FIG. 1 is a schematic illustration of an exemplary tire management system according to one embodiment of the invention;

FIG. 2 is an illustration of an underside view of one embodiment of an exemplary tire management system; and

FIG. 3 is an illustration of a side view of a vehicle according to one embodiment of the invention.

### DETAILED DESCRIPTION OF THE VARIOUS EMBODIMENTS

Referring now to the figures of the drawing, the figures constitute a part of this specification and illustrate exemplary embodiments of the invention. It is to be understood that in some instances various aspects of the invention may be shown exaggerated or enlarged to facilitate an understanding of the invention.

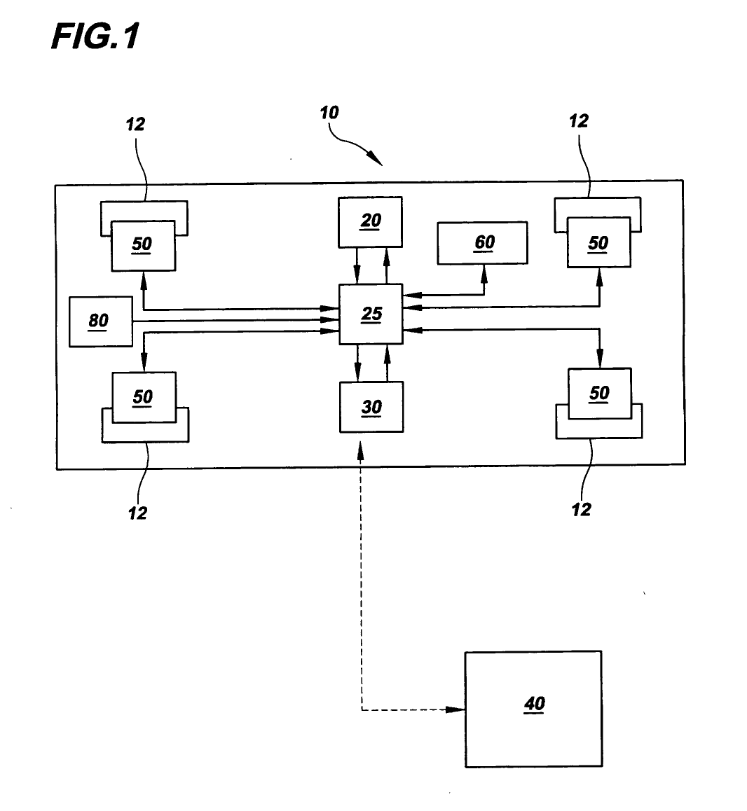

FIG. 1 is a schematic illustration of a tire management system and its operation according to one aspect of the invention. A representative vehicle 10 having tires 12 is shown. One or more pressure gauges 50 positioned on the vehicle 10, for example, on tires 12 and/or a CTI system 20 or elsewhere on the vehicle 10, measure tire pressures. In one embodiment, the tire management system includes at least one pressure gauge 50 positioned on each tire 12 of the vehicle 10 such that each pressure gauge 50 is uniquely identified by the tire management system. For example, each pressure gauge may send a signal or frequency along with the pressure reading that allows the tire management system or one or more of its elements to identify the origin of the pressure reading. The pressure gauges 50 transmit tire pressure information (and optionally other information such as tire temperature information) to a primary control unit 25 which monitors and controls tire pressure. In one embodiment, at least one pressure gauge 50 may be attached to a tire's inflation valve.

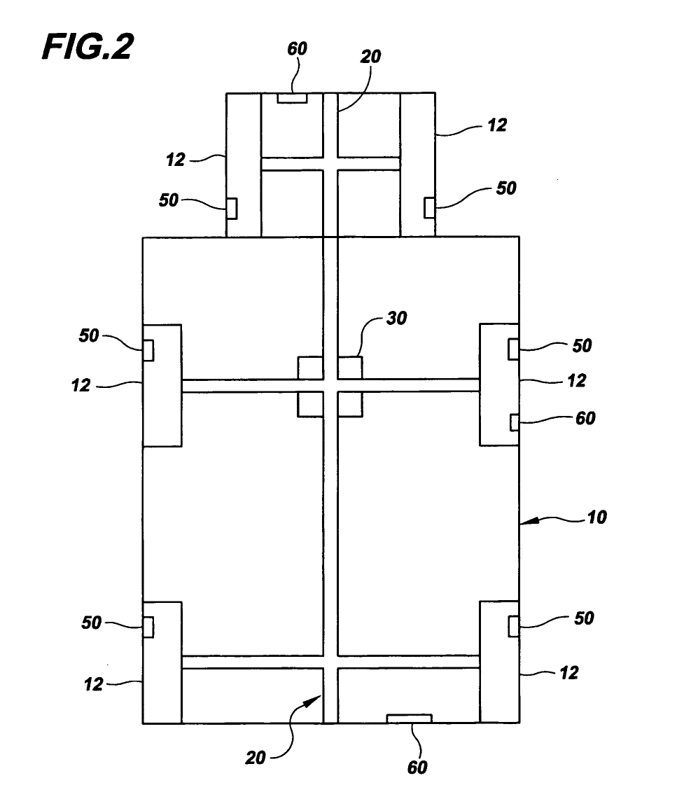

FIG. 2 is an illustration of an underside view of one embodiment of the invention. Positioned onboard the vehicle 10 is a CTI system 20 that is connected to the vehicle tires 12 so as to control the inflation and deflation of the tires by supplying and exhausting pressurized air. The CTI system 20 uses an onboard pressurized air source to supply pressurized air to the tires. In one embodiment, the CTI system 20 introduces pressurized air through one or more pressure control valves associated with each individual tire 12. The onboard pressurized air source provides pressurized air to each one of the tires through the tire's pressure control valve(s). Furthermore, the CTI system 20 transmits information to and receives control signals from an primary control unit 25. For example, the CTI system 20 may transmit information received from at least one pressure gauge 50 to the primary control unit 25. The primary control unit 25 analyzes the information and, for example, may determine that the corresponding tire pressure is too low to meet selected operational objectives. The primary control unit 25 may respond by sending a signal to the CTI system 20 to open the appropriate tire pressure control valve(s) and deliver pressurized air to the tires. In another example, the CTI system 20 may receive a signal from the primary control unit that the pressure in one or more of the tires 12 is too high, and instruct the CTI system 20 to open the appropriate corresponding tire pressure control valve(s) to exhaust pressurized air. In one embodiment, the CTI system 20 “talks” to the primary control unit 25 through microcontrollers and integrated circuits (ICs). Alternatively or in addition, the tire inflation/deflation system 20 communicates with the primary control unit 25 through a cable or wireless transmissions.

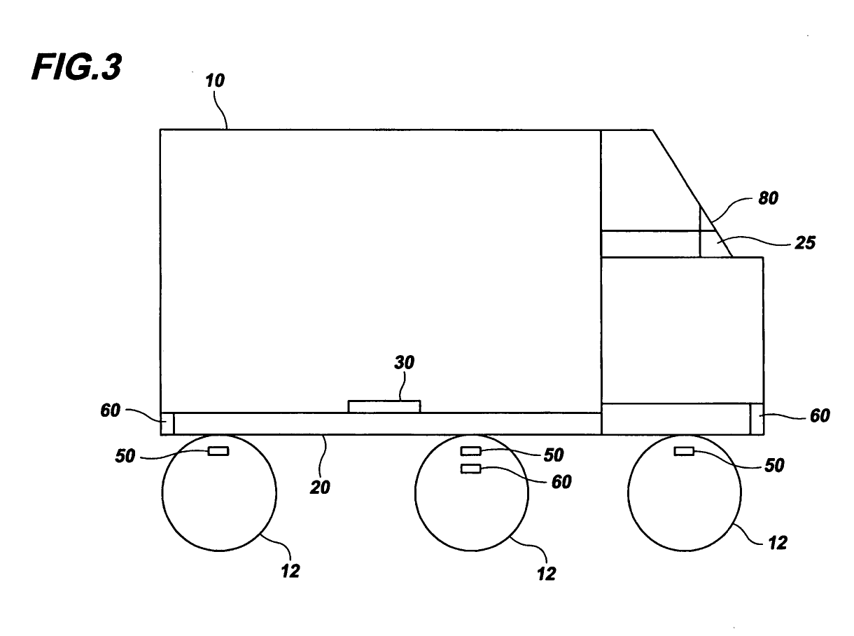

The primary control unit 25 provides operational control of the CTI system onboard the vehicle 10. The primary control unit 25 monitors and controls the pressure in the tires 12 by receiving tire pressure information from at least one pressure gauge 50 and/or the CTI system 20. For example, in one embodiment, the primary control unit 25 has a central RF receiver module that receives transmission data from pressure gauges 50 and/or the CTI system 20. FIG. 3 is an illustration of a side view of a vehicle according to one embodiment of the invention. The primary control unit 25 receives this data and optionally displays the data to a vehicle occupant (e.g. via a display screen and input panel 80). The primary control unit 25 may evaluate the data to determine whether any adjustment is necessary and transmit instructions to perform the adjustment to the CTI system 20. Alternatively, the primary control unit 25 may transmit instructions received from the input panel 80, to the CTI system 20. For example, the primary control unit 25 may compare tire pressure data to a preset target tire pressure. The target tire pressure may be generated by the primary control unit 25 in response to measured travel conditions (see below), received from a secondary control unit (see below), or input by a vehicle occupant at the display screen and input panel 80. The target tire pressure may be a range of pressures or a pressure plus or minus an allowable variation (e.g., within 5 psi of 80 psi).

A communication device 30 in electronic or wireless communication with the primary control unit 25 is remotely connected to a central secondary control unit 40 to enable wireless information exchange with the primary control unit 25. Communication device 30 may be separate from or integrated into primary control unit 25. Information that is transmitted to the primary control unit 25 from the pressure gauges 50 and/or the CTI system 20 is communicated to the central secondary control unit 40 by the communication device 30. In one embodiment, the central secondary control unit 40 provides operational control of the tire management system by remotely controlling the primary control unit 25. The central secondary control unit 40 (or operator thereof) may independently, or in conjunction with the primary control unit 25 (or the vehicle occupant), monitor and control the pressure in the tires 12 of the vehicle 10. The central secondary control unit 40 may receive instructions from an operator local to the central secondary control unit 40 and send those instructions to the primary control unit 25. The central secondary control unit 40 may receive operational data from the primary control unit 25 and calculate new target values, and then communicate these new values back to the primary control unit 25. The primary control unit 25 can output the new calculated target values to the display and input screen 80 and/or instruct the CTI system 20 to make necessary adjustments according to the new target values. Alternatively or in addition, the central secondary control until 40 is used to record, and/or report on data sent from the vehicle 10.

In one embodiment, the tire management system includes at least one additional condition-sensing component 60. Condition sensing components 60 provide additional information on environmental, vehicle, and tire status conditions that may affect the efficiency of tire and fuel consumption management and dictate tire inflation and deflation control operations. This information is transmitted to the primary control unit 25 and from there to the central secondary control unit 40. For example, the condition sensing components may include one or more of: a vehicle load weight sensing device; tire tread depth sensors; tread separation sensors; wheel balance sensors; wheel alignment sensors; axle alignment sensors; tire slippage sensors; receivers for data from the vehicles ABS; sensors that measure braking habits; vibration sensors to monitor road condition; a vehicle speed sensing device; an ambient temperature sensor; tire temperature sensors; a barometer to measure atmospheric pressure (from which altitude may be calculated); a GPS device; and a fuel consumption meter. In some embodiments, a tire pressure gauge is one variety of condition-sensing component. Other sensors and useful data related to vehicle operation may also be used and are well known to those skilled in the art.

In one embodiment, the primary control unit 25 receives data from one or more condition sensing components 60 and one or more tire pressure gauges 50. The primary control unit 25 may display these data to a vehicle occupant, for example, via display screen and input panel 80. A variety of devices exist that may be used for display and input panel 80. A touch screen display, a keyboard, mouse, touchpad, computer monitor, barcode scanner, printer, and speaker are all devices that can receive input, provide output, or both. Additional devices for receiving input from and/or providing output to a user are well known to those skilled in the art.

The vehicle occupant may also select operational objectives on display and panel 80. Operational objectives may simply include a target tire pressure. Alternatively or in addition, operational objectives may include a “softer” ride, which generally requires a decrease in tire pressure. In another example, an operational objective may include improved mileage, which generally requires an increase in pressure. These selections are transmitted as control signals to the primary control unit 25, which in turn controls the CTI system 20 and the pressure in the tires 12.

In another embodiment, the communication device 30 transmits data from the primary control unit 25 to the central secondary control unit 40. The secondary control unit 40 may display these data to a fleet manager or other operator. The operator may input a pressure and operational objectives into the secondary control unit 40, for example, via a display and input panel. The secondary control unit 40 may transmit the objective to the primary control unit 25, which then calculates the necessary tire pressure, or may calculate target tire pressures needed to achieve the objective and transmit the target tire pressure to the primary control unit 25. The primary control unit 25 receives the control signals from the central secondary control unit 40 and transmits appropriate instructions to the CTI system 20.

The primary control unit 25 may also include an automated component for controlling the CTI system 20 automatically without instructions from the vehicle occupant. The automated component may include predefined values to which the data are compared as they are measured to determine whether pressure adjustments are necessary. The predefined values may be modified by the vehicle operator or by the secondary control unit 40. For example, a fleet manager may input new values into the central secondary control unit 40 for transmission to the primary control unit 25. In addition, the primary control unit 25 may be equipped with a manual override accessible to the operator of the vehicle that is capable of temporarily overriding the present instructions and/or instructions received from the central secondary control unit 40.

In another embodiment, it is contemplated that each onboard device (e.g., pressure gauges 50, CTI system 20, and/or the tire pressure control valves) may have an integrated communications device such that the central secondary control unit 40 can communicate with each onboard device directly.

The central secondary control unit 40 may provide operational control to and receive transmitted information from multiple vehicles to improve the performance of an entire fleet of vehicles. For example, the central secondary control unit 40 may receive information from the primary control unit 25 of each of a fleet of vehicles. The central secondary control unit 40 may use the information transmitted from each vehicle 10 to monitor and control the pressure of each tire 12 of each individual vehicle 10 and respond to the changing location and driving conditions of each tire of each vehicle 10. In one embodiment, the central secondary control unit 40 transmits information to the primary control unit 25 of each vehicle 10 in the fleet, and the primary control unit 25 in turn transmits information to the CTI system 20, which alters the pressure in an identified tire 12 accordingly. In another embodiment, the primary control unit 25 displays a message to the vehicle occupant. The message may include but is not limited to notification that assistance will be provided at a certain time and location, directions to a location where assistance is available, or suggestions for instructions or operational objectives the vehicle occupant may provide manually to the primary control unit 25.

The availability to the secondary control unit 40 of data from a fleet of vehicles 10 enables the central secondary control unit 40 to leverage information from one vehicle for the benefit of other vehicles. For example, if one vehicle transmits information to the central secondary control unit 40 that it has encountered a pothole and has developed a flat tire, the location of the pothole may be transmitted to other vehicles to prevent similar mishaps. In addition, the central secondary control unit 40 can tell a local operator to send a new tire to the vehicle with the flat or send dispatch orders directly to an employee of the fleet owner or the tire service provider with the location of the vehicle and the request for a tire. If several vehicles along the same stretch of road experience a drop in vehicle speed, the central secondary control unit 40 can tell other vehicles in the vicinity that there may be heavy traffic in the area or suggest an alternative route.

For example, different embodiments of the method of the present invention allow for automatic or manual adjustment of tire pressure for changes in: (1) speed (tires that are underinflated should not be driven at high speeds); (2) load weight (more load weight requires more pressure); (3) road condition (poor roads require slower speeds and lower pressures to soften the ride while higher pressures are necessary for the higher speeds paved highways allow); (4) atmospheric pressure (a tire pumped to the correct pressure at the coast will be overinflated at higher altitudes), (5) ambient temperature (tires correctly pressurized to “cold” tire pressure when ambient temperature is low will be overinflated when ambient temperature is high), and (5) fuel consumption (inflating tires decreases fuel consumption).

A vehicle or fleet owner who leases tires from a tire management company/service provider has little or no incentive to maintain the tires or to operate the tires under conditions that will extend their useful life. A tire management company can lease the tires to the fleet or vehicle owner under condition that a monitoring and tire inflation/deflation system be installed on the relevant vehicles. The tire management company can then monitor the tires and take upon itself the responsibility of making sure the tire pressure is optimized for the particular road and loading conditions. The company can also provide better customer service by replacing tires when they start to show signs of excessive wear or weakness rather than after a blowout or a run-flat. In general, the teachings herein allow the responsibility and ability to monitor tire performance and condition to lie with the party that has the incentive to maintain the tires.

The system and method of the present invention improves the ability of a vehicle to perform its intended function. For example, the system and method of the present invention would allow an owner and/or operator of a fleet of commercial vehicles to monitor and control tire pressure of an entire fleet of vehicles from a central location, and minimize significant repair and maintenance necessary for maximum tire performance. By monitoring and controlling tire pressure according to the present invention, commercial vehicle productivity is improved by reducing tire and fuel expenses, improving traction and reducing tire-induced shock-load damage to the vehicle's axles, chassis and cargo. Increasing tire performance increases deliveries (as less time is wasted managing tires) and cuts costs (longer tire life and lower fuel consumption). A number of external factors (e.g. weather, road conditions, atmospheric pressure, etc.) influence tire performance, and tire pressure can be adjusted in response to such factors. In addition, other factors that influence tire performance regardless of tire pressure (e.g. driver habits, axle and wheel alignment) may be recorded by the primary control unit and/or central secondary unit and reported to an operator and/or to the driver so that remedial action can be taken.

Embodiments of the system and method of the present invention may also compile reports for vehicle and tire owners on potential tire problems before they occur. For example, in one embodiment, the system may implement tire pressure adjustments to avoid tire damage, alert the driver or central secondary control unit operator to a problem, or summon a tire service provider to the vehicle to perform preventative maintenance or repairs. In certain embodiments, the system records and reports on external factors that will lead to reduced tire productivity over time, such as deteriorating roads, poor driver habits, axle and wheel misalignment, imbalanced wheels and overloading. The system may record and report on unforeseeable tire problems, and may help to identify the cause of a problem so that preventative measures may be taken.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A tire management system, comprising:
a primary control unit positioned onboard a vehicle, said vehicle having at least one tire;
a central secondary control unit spaced apart from said vehicle and in wireless communication with said primary control unit;
a central tire inflation (CTI) system positioned onboard said vehicle and operationally controlled by said primary control unit; and
at least one pressure gauge disposed onboard said vehicle and adapted and constructed to measure tire pressure and transmit tire pressure information to said primary control unit.

2. The tire management system of claim 1, wherein said at least one pressure gauge is disposed in the CTI system.

3. The tire management system of claim 1, wherein said at least one pressure gauge is disposed at a tire.

4. The tire management system of claim 1, wherein the CTI system is in fluidic communication with an onboard pressurized air source for supplying pressurized air to the tires.

5. The tire management system of claim 1, wherein the CTI system is connected to at least one tire to control the inflation and deflation of the tire by supplying pressurized air.

6. The tire management system of claim 1, wherein the CTI system is connected to at least one tire to control the inflation and deflation of the tire by exhausting pressurized air.

7. The tire management system of claim 1, wherein at least one of the primary control unit and the central secondary control unit is adapted and constructed to monitor tire pressure using tire pressure information provided by the at least one pressure gauge.

8. The tire management system of claim 1, further comprising a communication device that provides said wireless communication.

9. The tire management system of claim 8, wherein said central secondary control unit is adapted and constructed to provide a target tire pressure, an operational objective, or both, for the primary control unit.

10. The tire management system of claim 1, further comprising at least one condition sensing component positioned onboard said vehicle, wherein said condition sensing component is adapted and constructed to transmit sensed information to said primary control unit.

11. The tire management system of claim 10, wherein said at least one condition sensing device is selected from the group consisting of: a vehicle load weight sensing device; tire tread depth sensor; tire tread separation sensor; wheel balance sensor; wheel alignment sensor; axle alignment sensor; tire slippage sensor; braking sensor; data link to an onboard ABS; road condition vibration sensor; a vehicle speed sensing device; an ambient temperature sensor; a tire temperature sensor; a barometer; a GPS device; a fuel consumption meter; and any combination thereof.

12. The tire management system of claim 1, further comprising:
a display and input panel positioned onboard said vehicle and adapted and constructed to allow input and output access by a vehicle occupant, wherein said panel is adapted and constructed to receive information signals from said primary control unit and input from said vehicle occupant.

13. The tire management system of claim 12, wherein said primary control unit is adapted and constructed to receive data from said at least one tire pressure gauge and display said data to said vehicle occupant on said display and input panel.

14. The tire management system of claim 10, further comprising:
a display and input panel positioned onboard said vehicle and adapted and constructed to allow input and output access by a vehicle occupant, wherein said display and input panel is adapted and constructed to receive information signals from said primary control unit and input from said vehicle occupant wherein said primary control unit is adapted and constructed to receive data from said at least one condition sensing component and said at least one tire pressure gauge and display said data to said vehicle occupant on said display and input panel.

15. The tire management system of claim 10, wherein said primary control unit is adapted and constructed to use data from at least one of said at least one tire pressure gauge and at least one condition sensing component to calculate a target tire pressure according to a predetermined operational objective.

16. The tire management system of claim 1 or 10, wherein said primary control unit is adapted and constructed to control the CTI system without real-time input from a vehicle occupant or said central secondary control unit.

17. The tire management system of claim 1 or 10, wherein said central secondary control unit is adapted and constructed to control the CTI system without real-time input from a user local to said central secondary control unit or a vehicle occupant.

18. The tire management system of claim 1 or 10, wherein said primary control unit is adapted and constructed to allow a vehicle occupant to exercise direct control over the CTI system.

19. The tire management system of claim 1 or 10, wherein said central secondary control unit is adapted and constructed to allow a user to exercise direct control over said CTI system.

20. The tire management system of claim 1, wherein said central secondary control unit is in electronic communication with a display and input panel wherein said central secondary control unit is adapted and constructed to receive operational data from said primary control unit and provide said data to said display and input panel.

21. The tire management system of claim 10, wherein said central secondary control unit is in electronic communication with a display and input panel, and wherein said central secondary control unit is adapted and constructed to receive data from said at least one condition sensing component and said at least one tire pressure gauge and display said data to said display and input panel.

22. The tire management system of claim 20 or 21, wherein said display and input panel is adapted and constructed to receive an input selected from a target tire pressure and an operational objective from a user and transmit said input to said central secondary control unit.

23. The tire management system of claim 20 or 21, wherein said central secondary control panel is adapted and constructed to receive an operational objective from a user and transmits a target tire pressure corresponding to said operational objective or said operational objective to said central secondary control unit.

24. The tire management system of claim 20, wherein said central secondary control unit is adapted and constructed to process data from said at least one tire pressure gauge to calculate a target tire pressure according to a predetermined operational objective.

25. The tire management system of claim 20, wherein said primary control unit is adapted and constructed to process data from said at least one tire pressure gauge to calculate a target tire pressure according to a predetermined operational objective.

26. The tire management system of claim 24 or 25, wherein said operational objective includes one or more of: increase in tire life; increase in traction; reduction in road damage; achievement of a tire pressure optimized for selected operational conditions; travel at a predetermined speed; travel on a particular surface; travel under a predetermined load weight; reduction in tire temperature; travel at a predetermined altitude; reduction of fuel consumption; and achievement of a predetermined contact area between a tire and a surface.

27. The tire management system of claim 1 or 10, further comprising:
a plurality of primary control units, each positioned onboard a vehicle having a CTI system, wherein said CTI system is operationally controlled by the primary control unit onboard its respective vehicle,
wherein each primary control unit is in wireless communication with said central secondary control unit.

28. The tire management system of claim 27, wherein each of said plurality of primary control units is adapted and constructed to maintain a target tire pressure in tires attached to the vehicle having the primary control unit, and wherein the target tire pressure is not the same for each primary control unit.

29. The tire management system of claim 27, wherein each of said plurality of primary control units is adapted and constructed to maintain a tire pressure in tires attached to the vehicle having the primary control unit according to a predetermined operational objective, and wherein the operational objective is not the same for each primary control unit.

30. The tire management system of claim 27, wherein said central secondary control unit is adapted and constructed to calculate a target tire pressure for each vehicle based on a predetermined operational objective, wherein the operational objective is not the same for each vehicle.

31. The tire management system of claim 30, wherein said central secondary control unit is adapted and constructed to calculate said operational objective for each vehicle using data received from said vehicle.

32. The tire management system of claim 31, wherein said central secondary control unit is adapted and constructed to calculate said operational objective for each vehicle using data received from a different vehicle.

33. A method of tire management, comprising:
obtaining operational condition data using at least one condition sensing component positioned onboard a vehicle; and
transmitting said operational condition data to a central secondary control unit spaced apart from said vehicle.

34. The method of claim 33, further comprising:
displaying said operational condition data on a first display and input panel onboard said vehicle.

35. The method of claim 33, further comprising:
displaying said operational condition data on a second display and input panel in electronic communication with said central secondary control unit.

36. The method of claim 33, further comprising sending control signals to a CTI system disposed on said vehicle, wherein said CTI system maintains a target pressure in at least one tire of said vehicle according to said control signals.

37. The method of claim 33, further comprising transmitting said operational condition data to a primary control unit onboard said vehicle, wherein transmitting said operational data to a central secondary control unit comprises transmitting said operational data from said primary control unit to said central secondary control unit.

38. The method of claim 37, further comprising:
receiving an operational objective at said primary control unit from said central secondary control unit, wherein said primary control unit sends control signals to a CTI system disposed on said vehicle according to said operational objective, and wherein said CTI system maintains a target tire pressure in at least one tire of said vehicle according to said control signals.

39. The method of claim 33, further comprising receiving input from a user local to said central secondary control unit and maintaining a target pressure in at least one tire of said vehicle according to said input.

40. The method of claim 39, wherein said input comprises a target tire pressure, an operational objective, or both.

41. The method of claim 37, further comprising:
receiving input to the primary control unit; and
maintaining a target pressure in at least one tire of said vehicle according to said input.

42. The method of claim 33, further comprising:
communicating control signals to a CTI system disposed onboard said vehicle, wherein said CTI system adjusts pressure in at least one tire of said vehicle according to said control signals, wherein the control signals are based upon predetermined operational objectives.

43. The method of claim 37, further comprising:
communicating control signals to a CTI system disposed onboard said vehicle, wherein said CTI system adjusts pressure in at least one tire of said vehicle according to said control signals, wherein said control signals are based upon predetermined operational objectives.

44. The method of claim 33, further comprising:
recording at least a portion of said operational condition data in said central secondary control unit.

45. The method of claim 33, further comprising:
reporting at least a portion of said operational condition data to a vehicle occupant, a user local to said central secondary control unit, or both.

46. The method of claim 33, wherein the condition sensing component may sense one or more of the following: tire pressure; vehicle load weight; tire tread depth; tire tread separation; wheel balance; wheel alignment; axle alignment tire slippage; braking strength; data link from an onboard ABS; road condition; axle vibration; vehicle speed; ambient temperature; tire temperature; altitude; atmospheric pressure; geographic location; fuel consumption level; and fuel consumption rate.

47. A method of tire management, comprising:
receiving operational condition data from a vehicle at a location spaced apart from the vehicle, wherein said operational condition data is collected from at least one condition sensing component positioned onboard the vehicle.

48. The method of claim 47, wherein said operational condition data are received at a central secondary control unit.

49. The method of claim 48, further comprising setting an operational objective for said vehicle at said central secondary control unit, wherein said central secondary control unit transmits said operational objective, a target tire pressure, or both to said vehicle.

50. The method of claim 49, wherein said operational objective comprises one or more of: target tire pressure; increase in tire life; increase in traction; reduction in road damage; achievement of a tire pressure optimized for a predetermined operational condition; travel at a predetermined speed; travel on a predetermined surface; travel under a predetermined load weight; reduction in tire temperature; travel at a particular altitude; reduction of fuel consumption; and achievement of a predetermined contact area between a tire and a surface.

51. The method of claim 48, further comprising causing a service provider to visit said vehicle in response to said received operational condition data.

52. The method of claim 48, further comprising receiving operational condition data from a plurality of vehicles at a location spaced apart from at least a portion of said plurality of vehicles.

53. The tire management system of claim 52, wherein said central secondary control unit transmits a predetermined operational objective to at least a portion of said plurality of vehicles, wherein said operational objective is not the same for each of said plurality of vehicles.

54. The tire management system of claim 52, wherein said central secondary control unit calculates a target tire pressure for at least a portion of said plurality of vehicles based on a predetermined operational objective, wherein the operational objective is not the same for each of said plurality of vehicles.

55. The tire management system of claim 52, wherein said central secondary control unit calculates an operational objective for each vehicle using data received from at least a portion of said plurality of vehicles.
